(19) United States
(12) Patent Application Publication
(10) Pub. No.: US 2019/0193469 A1
(43) Pub. Date: Jun. 27, 2019

(54) PNEUMATIC TIRE

(71) Applicant: TOYO TIRE & RUBBER CO., LTD., Itami-shi (JP)

(72) Inventor: Souichi Takahashi, Itami-shi (JP)

(73) Assignee: TOYO TIRE & RUBBER CO., LTD., Itami-shi (JP)

(21) Appl. No.: 16/217,472

(22) Filed: Dec. 12, 2018

(30) Foreign Application Priority Data
Dec. 26, 2017 (JP) 2017-249723

(51) Int. Cl. B60C 11/03

(52) U.S. Cl. CPC B60C 11/033; B60C 11/1259; B60C 11/0304

(57) ABSTRACT

In a pneumatic tire, a total area of those among a land grooves which are at an outboard shoulder land portion is less than a total area of those among the land grooves which are at an inboard shoulder land portion, an average intersection angle at which those among the outwardly open grooves which are at the outboard shoulder land portion intersect a tire width direction is less than an average intersection angle at which those among the outwardly open grooves which are at the inboard shoulder land portion intersect the tire width direction.

### CROSS REFERENCE TO RELATED APPLICATIONS

This application claims the benefit of priority of Japanese application no. 2017-249723, filed on Dec. 26, 2017, which is incorporated herein by reference.

### BACKGROUND OF THE INVENTION

### Field of the Invention

The present invention relates to a pneumatic tire.

### Description of the Related Art

Conventionally a pneumatic tire might, for example, comprise shoulder land portion(s) partitioned by contact patch end(s) and shoulder main groove(s) arranged in outwardmost fashion in the tire width direction. In addition, shoulder land portion(s) might comprise a plurality of outwardly open grooves extending as far as the contact patch end(s) (e.g., JP 2006-192929 A).

But to improve anti-hydroplaning performance (i.e., ability to suppress occurrence of hydroplaning), it is necessary to increase groove area. However, increasing groove area results in a decrease in antinoise performance (i.e., decreased ability to suppress the magnitude of noise that leaks to the exterior). Accordingly, there is demand for a pneumatic tire that permits suppression of reduction in anti-hydroplaning performance and yet also permits suppression of reduction in antinoise performance.

### SUMMARY OF THE INVENTION

The problem is therefore o provide a pneumatic tire that will make it possible to suppress reduction in anti-hydroplaning performance and yet also make it possible to suppress reduction in antinoise performance.

There is provided a pneumatic tire includes:

a plurality of main grooves extending in a tire circumferential direction;

a plurality of land portions that are partitioned by at least one contact patch end and the plurality of main grooves; and

at least one indicator region that indicates a vehicle mounting direction;

wherein the plurality of main grooves include an outboard shoulder main groove arranged in outwardmost fashion when the tire is mounted on a vehicle, and an inboard shoulder main groove arranged in inwardmost fashion when the tire is mounted on the vehicle;

the plurality of land portions include an outboard shoulder land portion partitioned by the at least one contact patch end and the outboard shoulder main groove, and a inboard shoulder land portion partitioned by the at least one contact patch end and the inboard shoulder main groove;

the outboard shoulder land portion and the inboard shoulder land portion respectively comprise a plurality of land grooves or groove width not less than 1.6 mm;

the plurality of land grooves comprise a plurality of outwardly open grooves that extend as far as the at least one contact patch end;

a total area of those among the land grooves which are at the outboard shoulder land portion is less than a total area of those among the land grooves which are at the inboard shoulder land portion; and

an average intersection angle at which those among the outwardly open grooves which are at the outboard shoulder land portion intersect a tire width direction is less than an average intersection angle at which those among the outwardly open grooves which are at the inboard shoulder land portion intersect the tire width direction.

Further, the pneumatic tire may have a configuration in which:

an average groove width of those among the outwardly open grooves which are at the outboard shoulder land portion is less than an average groove width of those among the outwardly open grooves which are at the inboard shoulder land portion.

Further, the pneumatic tire may have a configuration in which:

a fractional percentage of inner ends in the tire width direction of those among the outwardly open grooves which are at the outboard shoulder land portion and which are contiguous with at least one of the shoulder main grooves is less than a fractional percentage of inner ends in the tire width direction of those among the outwardly open grooves which are at the inboard shoulder land portion and which are contiguous with at least one of the shoulder main grooves.

Further, the pneumatic tire may have a configuration in which:

all of the inner ends in the tire width direction of those among the outwardly open grooves which are at the outboard shoulder land portion are contiguous with the outboard shoulder main grooves.

Further, the pneumatic tire may have a configuration in which:

all of the inner ends in the tire width direction of those among the outwardly open grooves which are at the inboard shoulder land portion are separated from the inboard shoulder main grooves.

Further, the pneumatic tire may have a configuration in which:

a ratio of the total area of the land grooves at the outboard shoulder land portion is 70% to 90% of the total area of the land grooves at the inboard shoulder land portion.

Further, the pneumatic tire may have a configuration in which:

the average intersection angle at which those among the outwardly open grooves which are at the outboard shoulder land portion intersect the tire width direction is 5° to 15°; and

the average intersection angle at which those among the outwardly open grooves which are at the inboard shoulder land portion intersect the tire width direction is 10° to 25°.

Further, the pneumatic tire may have a configuration in which:

a void ratio of the land grooves of groove width not less than 1.6 mm at the outboard shoulder land portion is less than a void ratio of the land grooves of groove width not less than 1.6 mm at the inboard shoulder land portion.

Further, the pneumatic tire may have a configuration in which:

the plurality of land portions comprise a plurality of middle land portions arranged between the outboard shoulder land portion and the inboard shoulder land portion;

the plurality of middle land portions include at least one outboard middle land portion arranged to the exterior side of a tire equatorial plane when the tire is mounted on the vehicle, and at least one inboard middle land portion arranged to the interior side of the tire equatorial plane when the tire is mounted on the vehicle;

the at least one outboard middle land portion and the at least one inboard middle land portion respectively comprise a plurality of land grooves of groove width not less than 1.6 mm; and

a total area of those among the land grooves which are at the at least one outboard middle land portion is less than a total area of those among the land grooves which are at the at least one inboard middle land portion.

### BRIEF DESCRIPTION OF DRAWINGS

FIG. 1 is a view of a section, taken along a tire meridional plane, of the principal components in a pneumatic tire associated with an embodiment;

FIG. 2 is a drawing showing a tread surface of the principal components in a pneumatic tire associated with same embodiment as they would exist if unwrapped so as to lie in a single plane;

FIG. 3 is an enlarged view of region III in FIG. 2;

FIG. 4 is an enlarged view of region IV in FIG. 2;

FIG. 5 is a drawing showing the surface shape that comes in contact with the road surface at a pneumatic tire associated with same embodiment; and

FIG. 6 is a table showing results of evaluation of examples and comparative examples of a pneumatic tire.

### DETAILED DESCRIPTION OF THE INVENTION

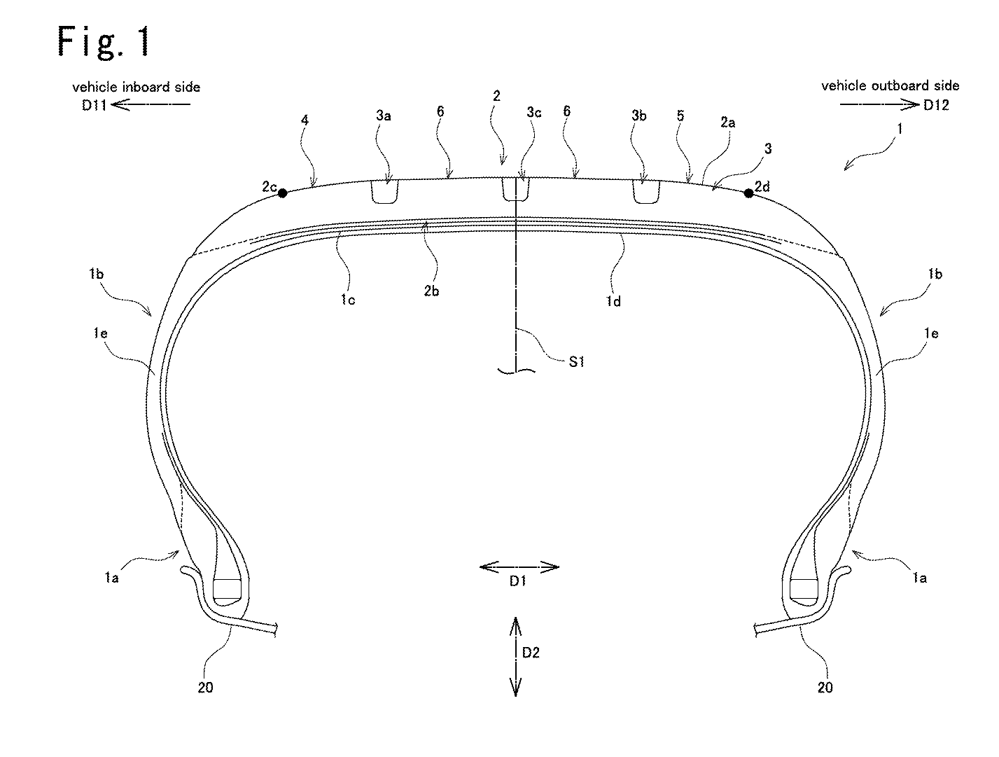

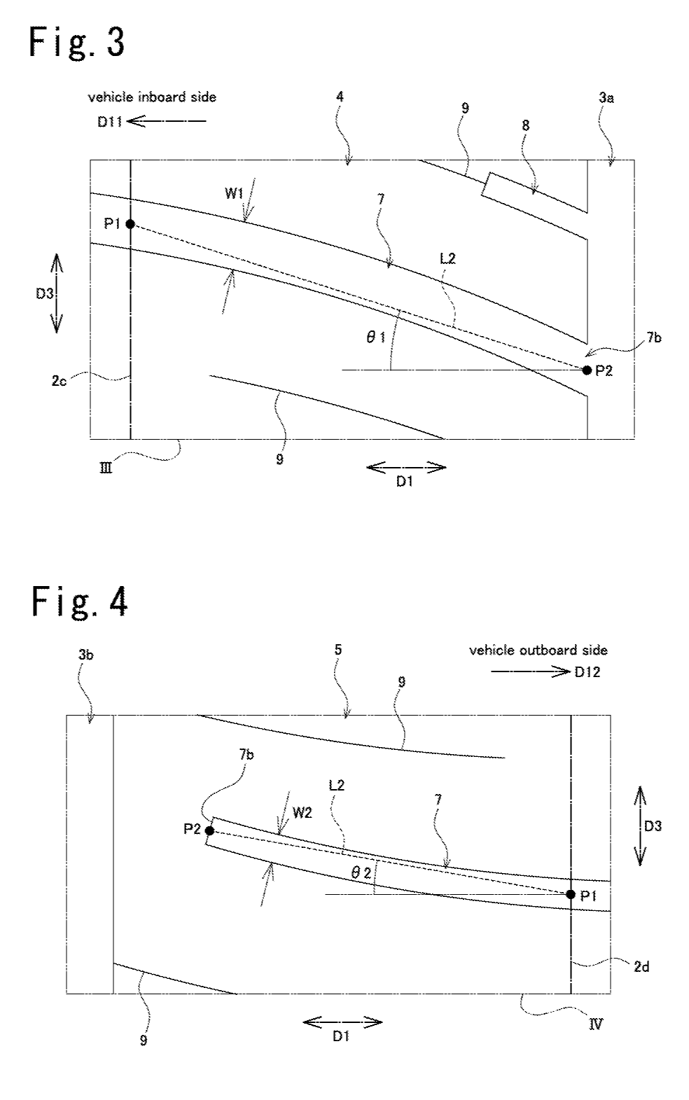

Below, an embodiment of a pneumatic tire is described with reference to FIG. 1 through FIG. 6. At the respective drawings, note that dimensional ratios at the drawings and actual dimensional ratios are not necessarily consistent, and note further that dimensional ratios are hot necessarily consistent from drawing to drawing.

At the respective drawings, first direction D1 is the tire width direction D1 which is parallel to the tire rotational axis which is the center of rotation of pneumatic tire (hereinafter also referred to as simply “tire”) 1, second direction D2 is the tire radial direction D2 which is the direction of the diameter of tire 1, and third direction D3 is the tire circumferential direction D3 which is circumferential with respect to the rotational axis of the tire. Note that the tire width direction D1 may be further subdivided into first side D11, which is also referred to as first width direction side D11; and second side D12, which is also referred to as second width direction side D12.

Tire equatorial plane S1 refers to a plane that is located centrally in the tire width direction D1 of tire 1 and that is perpendicular to the rotational axis of the tire; tire meridional planes refer to planes that are perpendicular to tire equatorial plane S1 and that contain the rotational axis of the tire. Furthermore, the tire equator L1 is the curve formed by the intersection of tire equatorial plane S1 and the outer surface (tread surface 2a, described below) in the tire radial direction D2 of tire 1.

As shown in FIG. 1, tire 1 associated with the present embodiment is provided with a pair of bead regions 1a at which beads are present; sidewall regions 1b which extend outwardly in the tire radial direction D2 from the respective bead regions 1a; and tread region 2, the exterior surface in the tire radial direction D2 of which contacts the road surface and which is contiguous with the outer ends in the tire radial direction D2 of the pair of sidewall regions 1b. In accordance with the present embodiment, tire 1 is a pneumatic tire 1, the interior of which is capable of being filled with air, and which is capable of being mounted on a rim 20.

Furthermore, tire 1 is provided with carcass layer 1c which spans the pair of beads, and innerliner layer 1d which is arranged at a location toward the interior from carcass layer 1c and which has superior functionality in terms of its ability to impede passage of gas therethrough so as to permit air pressure to be maintained. Carcass layer 1c and innerliner layer 1d are arranged in parallel fashion with respect to the inner circumferential surface of the tire over a portion thereof that encompasses bead regions 1a, sidewall regions 1b, and tread region 2. Tread region 2 is provided with tread rubber 3 having tread surface 2a which contacts the road surface, and belt layer 2b which is arranged between tread rubber 3 and carcass layer 1c.

Tire 1 has a structure that is asymmetric with respect to tire equatorial plane 31. In accordance with the present embodiment, tire 1 is a tire for which a vehicle mounting direction is indicated, which is to say that there is an indication of whether the left or the right side of the tire should be made to face the vehicle when tire 1 mounted on rim 20. Moreover, the tread pattern formed at the tread surface 2a at tread region 2 is asymmetric with respect to tire equatorial plane S1.

The orientation in which the tire is to be mounted on the vehicle is indicated at sidewall region 1b. More specifically, sidewall region 1b is provided with sidewall rubber 1e which is arranged toward the exterior in the tire width direction D1 from carcass layer 1c so as to constitute the tire exterior surface, the surface of said sidewall rubber 1e having an indicator region.

For example, one sidewall region 1b, i.e., that which is to be arranged toward the inboard side (left side at the drawings; hereinafter also referred to as “vehicle inboard side”) of the mounted tire, is marked (e.g., with the word “INSIDE” or the like) so as to contain an indication to the effect that it is for the vehicle inboard side. While for example, the other sidewall region 1b, i.e., that which is to be arranged toward the outboard side (right side at the drawings; hereinafter also referred to as “vehicle outboard side”) of the mounted tire is marked (e.g., with the word “OUTSIDE” or the like) so as to contain an indication to the effect that it is for the vehicle outboard side. In accordance with the present embodiment, first width direction side D11 is taken to be the vehicle inboard side, and second width direction side D12 is taken to be the vehicle outboard side.

Present at tread surface 2a is the contact patch that actually comes in contact with the road surface, and the portions within said contact patch that are present at the outer ends in the tire width direction D1 are referred to as contact patch ends 2c, 2d. Note that said contact patch refers to the portion of the tread surface 2a that comes in contact with the road surface when a normal load is applied to a tire 1 mounted on a normal rim 20 when the tire 1 is inflated to normal internal pressure and is placed in vertical orientation on a flat road surface. Furthermore, of the ends 2c, 2d of the contact patch, the end 2c on the first width direction side D11 of the contact patch is referred to as the inboard contact patch end 2c; and the end 2d on the second width direction side D12 of the contact patch is referred to as the outboard contact patch end 2d.

Normal rim 20 is that particular rim 20 which is specified for use with a particular tire 1 in the context of the body of standards that contains the standard that applies to the tire 1 in question, this being referred to, for example, as a standard rim in the case of JATMA, a “Design Rim” in the case of TRA, or a “Measuring rim” in the case of ETRTO.

Normal internal pressure is that air pressure which is specified for use with a particular tire 1 in the context of the body of standards that contains the standard that applies to the tire 1 in question, this being maximum air pressure in the case of JATMA, the maximum value listed at the table entitled “TIRE LOAD LIMITS AT VARIOUS COLD INFLATION PRESSURES” in the case of TRA, or “INFLATION PRESSURE” in the case of ETRTO, which when tire 1 is to used on a passenger vehicle is taken to be an internal pressure of 180 KPa.

Normal load is that load which is specified for use with a particular tire 1 in the context of the body of standards that contains the standard that applies to the tire 1 in question, this being maximum load capacity in the case of JATMA, the maximum value listed at the aforementioned table in the case of TRA, or “LOAD CAPACITY” in the case of ETRTO, which when tire 1 is to be used on a passenger vehicle is taken to be 85% of the load corresponding to an internal pressure of 180 KPa.

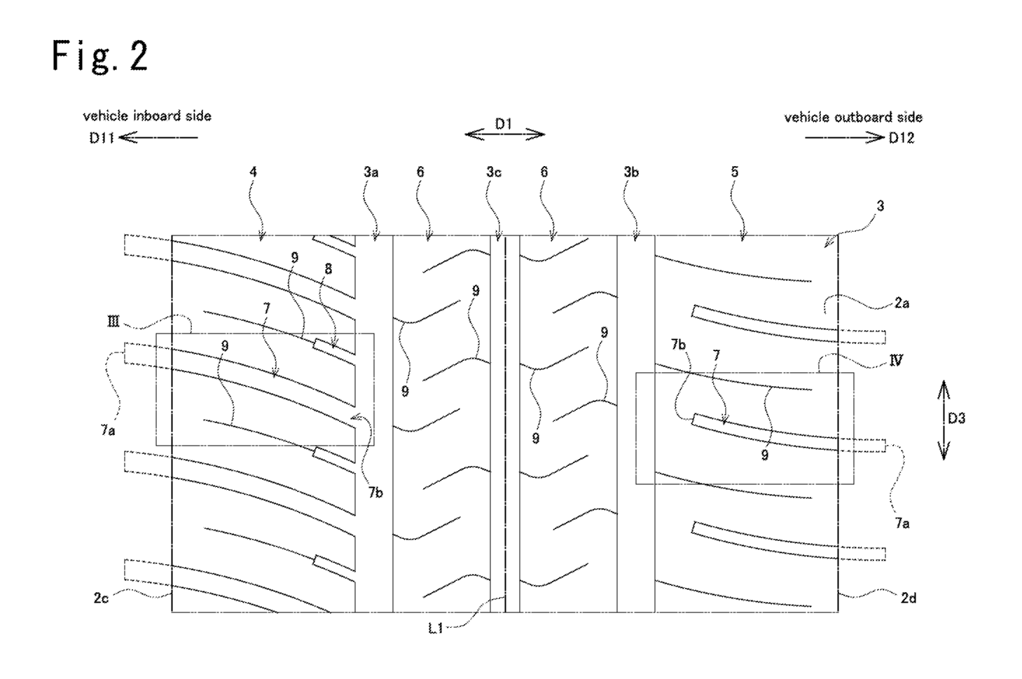

As shown in FIG. 1 and FIG. 2, tread rubber 3 is provided with a plurality of main grooves 3a through 3c extending in the tire circumferential direction D3. Main groove 3a through 3c extends continuously in the tire circumferential direction D3. Note that whereas main grooves 3a through 3c extend in straight fashion in the tire circumferential direction D3 in the present embodiment, there is no limitation with respect to such constitution, it also being possible to adopt a constitution in which these are, for example, repeatedly bent such that they extend in zigzag fashion, or a constitution in which these are, for example, repeatedly curved such that they extend in wavy fashion.

Main groove 3a through 3c might, for example, be provided with so-called tread wear indicator(s) (not shown) which are portions at which depth of the groove is reduced so as to make it possible to ascertain the extent to which wear has occurred as a result of the exposure thereof that takes place in accompaniment to wear. Furthermore, main groove 3a through 3c might, for example, have a width that is not less than 3% of the distance (dimension in the tire width direction D1) between contact patch ends 2c, 2d. Furthermore, main groove 3a through 3c might, for example, have a width that is not less than 5 mm.

Furthermore, at the plurality of main grooves 3a through 3c, the pair of main grooves 3a, 3b arranged at outermost locations in the tire width direction D1 are referred to as shoulder main grooves 3a, 3b, and the main groove(s) 3c arranged between the pair of shoulder main grooves 3a, 3b are referred to as center main groove(s) 3c. Note that whereas in the present embodiment the number of center main groove(s) 3c that are present is one, there is no limitation with respect to such constitution, it also being possible, for example, for there to be two or more thereof. Note, shoulder main groove 3a at the first width direction side D11 is referred to as inboard shoulder main groove 3a, and shoulder main groove 3b at the second width direction side D12 is referred to as outboard shoulder main groove 3b.

Tread rubber 3 is provided with a plurality of land portions 4 through 6 which are partitioned by main grooves 3a through 3c and contact patch ends 2c, 2d. At the plurality of land portions 4 through 6, land portion(s) 4, 5 which are partitioned by shoulder main groove(s) 3a, 3b and contact patch ends 2c, 2d are referred to as shoulder land portion(s) 4, 5, and land portion(s) 6, 6 which are partitioned by respective main grooves 3a(3b), 3c adjacent thereto and which are arranged between the pair of shoulder land portion (s) 4, 5 are referred to as middle land portion (s) 6, 6.

Note that shoulder land portion(s) 4, 5 are arranged at location(s) toward the exterior in the tire width direction D1 from shoulder main groove(s) 3a, 3b. In addition, shoulder land portion 4 at the first width direction side D11 are referred to as inboard shoulder land portion 4, and shoulder land portion 5 at the second width direction side D12 are referred to as outboard shoulder land portion 5.

Land portions 4 through 6 comprise a plurality of land grooves 7, 8 of groove width not less than 1.6 mm, and a plurality of sipes 9 of groove width less than 1.6 mm. In addition, the plurality of land grooves 7, 8 and the plurality of sipes 9 extend so as to intersect the tire circumferential direction D3. Note, moreover, that land portions 4 through 6 may comprise land groove(s) that extend in continuous or intermittent fashion in the tire circumferential direction D3 and that are of groove width(s) less than the groove width(s) of main grooves 3a through 3c.

Furthermore, among the plurality of land grooves 7, 8, land groove(s) 7 that extend as far as contact patch end(s) 2c, 2d are referred to as outwardly open groove(s) 7. That is, outer end 7a in the tire width direction D1 of outwardly open groove(s) 7 are arranged toward the exterior in the tire width direction D1 from contact patch end 2c, 2d. This being the case, outwardly open groove(s) 7 are open at the location(s) of contact patch end 2c, 2d.

The constitutions of land grooves 7, 8 at shoulder land portions 4, 5 will now be described with reference to FIG. 2 through FIG. 4.

First, because an increase in groove area will facilitate flow of water at the interior of the groove, this will make it possible to cause water shedding to be carried out in an efficient manner. On the other hand, because an increase in groove area will also facilitate propagation of noise, this will increase the amount of noise that leaks to the exterior. Furthermore, because an increase in groove area will increase the amount of alteration in groove area that is produced in accompaniment to elastic deformation of tire 1, this will increase the amount of noise which is produced that is attributable thereto.

But because noise arising from regions toward the outboard side has a greater tendency to leak to the exterior than noise arising from regions toward the inboard side, to improve antinoise performance it will be effective to suppress production of noise at regions toward the outboard side. On the other hand, regarding performance with respect to water shedding, i.e., anti-hydroplaning performance, there is not a great deal of difference in terms of effect depending on whether groove area is increased at regions toward the inboard side or groove area is increased at regions toward the outboard side.

As shown in FIG. 2 through 4, average groove width W2 of outwardly open groove(s) (hereinafter also referred to as simply “outboard outwardly open groove(s)”) 1 at outboard shoulder land portion 5 is therefore made smaller than average groove width W1 of outwardly open groove(s) (hereinafter also referred to as simply “inboard outwardly open groove”) 7 at inboard shoulder land portion 4. As a result, area of outboard outwardly open groove(s) 7 is reduced, and area of inboard outwardly open groove(s) 7 is increased.

For example, it is preferred that the ratio of the average groove width W2 of outboard outwardly open groove(s) 7 to the average groove width W1 of inboard outwardly open groove(s) 7 be, for example, not greater than 95%, more preferred that this be not greater than 90%, and very much preferred that this be not greater than 85%. Note, however, that there is no particular limitation with respect to said ratio.

Furthermore, the average intersection angle θ2 at which outboard outwardly open groove(s) 7 intersect the tire width direction D1 is made smaller than the average intersection angle θ1 at which inboard outwardly open groove(s) 7 intersect the tire width direction D1. As a result, because this will result in a tendency for length(s) of outboard outwardly open groove(s) 7 to decrease, this will cause area(s) of outboard outwardly open groove(s) 7 to decrease; and because this will result in a tendency for length(s) of inboard outwardly open groove(s) 7 to increase, this will cause area(s) of inboard outwardly open groove(s) 7 to increase.

For example, it is preferred that the ratio of the average intersection angle θ2 at which outboard outwardly open groove(s) intersect the tire width direction D1 to the average intersection angle θ1 at which inboard outwardly open groove(s) 7 intersect the tire width direction D1 be not greater than 80%, more preferred that this be not greater than 70%, and very much preferred that this be not greater than 60%. Note, however, that there is no particular limitation with respect to said ratio.

Furthermore, while there is no particular limitation with respect to the average intersection angle θ1 at which inboard outwardly open groove(s) 7 intersect the tire width direction D1, it is, for example, preferred that this be 10% to 25%. In addition, while there is no particular limitation with respect to the average intersection angle θ2 at which outboard outwardly open groove(s) 7 intersect the tire width direction D1, it is, for example, preferred that this be 5% to 15%.

Because the area of outboard outwardly open groove(s) 7 is thus made small, the total area of land grooves 7, 8 at outboard shoulder land portion is made small. In contradistinction thereto, because the area of inboard outwardly open groove(s) 7 is made large, the total area of land grooves 7 at inboard shoulder land portion 4 is made large.

This causes the total area of land grooves 7, 8 at outboard shoulder land portion 5 to be less than the total area of land grooves 7 at inboard shoulder land portion 4. Accordingly, land grooves 7 at inboard shoulder land portion 4 make it possible to suppress reduction in anti-hydroplaning performance, and land grooves 7, 8 at outboard shoulder land portion 5 make it possible to suppress reduction in antinoise performance.

A distinction is thus made with respect to the function that is demanded of inboard shoulder land portion 4 versus the function that is demanded of outboard shoulder land portion 5. More specifically, the constitution at inboard shoulder land portion 4 is a constitution that will improve anti-hydroplaning performance, and the constitution at outboard shoulder land portion is a constitution that will improve antinoise performance. Moreover, while there is no particular limitation with respect to the ratio of the total area of land grooves 7, 8 at outboard shoulder land portion 5 to the total area of land grooves 7 at inboard shoulder land portion 4, it is, for example, preferred that this be 70% to 90%.

Note that the intersection angle θ1, θ2 at which outwardly open grooves 7 intersect the tire width direction D1 are the intersection angles θ1, θ2 at which reference lines L2 of outwardly open grooves 7 intersect the tire width direction D1. Here, what is referred to as a reference line L2 of an outwardly open groove 7 is a straight line drawn so as to connect the center P1 of the groove width at the contact patch end 2c, 2d at outwardly open groove 7 with the center P2 of the groove width at the inner end 7b of outwardly open groove 7.

Furthermore, inner end 7b in the tire width direction D1 of inboard outwardly open groove 7 is contiguous with inboard shoulder main groove 3a. This will make it possible to cause water at the interior of inboard outwardly open groove 7 to be shed therefrom in an efficient manner.

In contradistinction thereto, inner end 7b in the tire width direction D1 of outboard outwardly open groove 7 is separated from outboard shoulder main groove 3b, being located at the interior of outboard shoulder land portion 5. That is, inner end 7b of outboard outwardly open groove 7 terminates at the interior of outboard shoulder land portion 5, being closed. As a result, because the fact that one end of the column of air formed by the road surface and outboard outwardly open groove 7 is closed causes said column of air to be short, this makes it possible to efficiently suppress production of noise.

The fractional percentage of inner ends 7b of outboard outwardly open grooves 7 that are contiguous with shoulder main groove 3b is thus made less than the fractional percentage of inner ends 7b of inboard outwardly open grooves 7 that are contiguous with shoulder main groove 3a. As a result, it will be possible to effectively suppress reduction in anti-hydroplaning performance, and it will be possible to efficiently suppress reduction in antinoise performance.

For example, it is preferred that the ratio of the fractional percentage of inner ends 7b of outboard outwardly open grooves 7 that are contiguous with shoulder main groove 3b to the fractional percentage of inner ends 7b of inboard outwardly open grooves 7 that are contiguous with shoulder main groove 3a be not greater than ½, and more preferred that this be not greater than ⅓. Note, however that there is no particular limitation with respect to said ratio.

Furthermore, it is very much preferred, for example, that the fractional percentage of inner ends 7b of inboard outwardly open grooves 7 that are contiguous with shoulder main groove 3a be 100%. Furthermore, it is very much preferred, for example, that the fractional percentage of inner ends 7b of outboard outwardly open grooves 7 that are contiguous with shoulder main groove 3b be 0%.

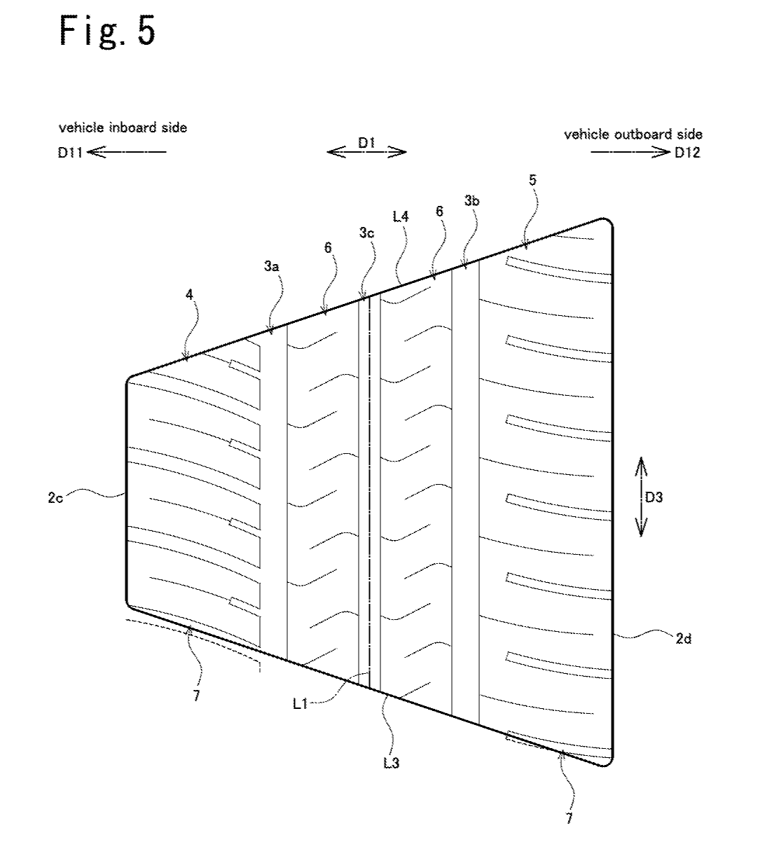

As shown in FIG. 5, note that the shape of the contact patch of tire 1 during steering or turning is such that contact patch length (length in the tire circumferential direction D3 of the contact patch) is greater toward the second width direction side D12, i.e., toward the outboard side D12. Accordingly, edges L3, L4 of the surface shape that comes in contact with the road of tire 1 will be greatly inclined with respect to the tire width direction D1.

To address this, because intersection angle θ2 of outboard outwardly open groove 7 with respect to the tire width direction D1 is made small, it is possible to suppress outboard outwardly open groove 7 from becoming located along edges L3, L4 of the surface shape that comes in contact with the road during steering. Accordingly, it is possible to suppress reduction in antinoise performance during steering.

Moreover, because intersection angle θ1 of inboard outwardly open groove 7 with respect to the tire width direction D1 is made large, inboard outwardly open groove 7 will be located along edge L3 of the surface shape that comes in contact with the road during steering. Note that because the noise produced by inboard shoulder land portion 4 does not tend to leak to the exterior, the noise that is produced which is attributable to this exerts little overall influence. Accordingly, reduction in antinoise performance can be suppressed.

As described above, the pneumatic tire 1 of the embodiment includes: a plurality of main grooves 3a through 3c extending in a tire circumferential direction D3; a plurality of land portions 4 through 6 that are partitioned by at least one contact patch end 2c, 2d and the plurality of main grooves 3a through 3c; and at least one indicator region that indicates a vehicle mounting direction;

wherein the plurality of main grooves 3a through 3c include an outboard shoulder main groove 3b arranged in outwardmost fashion when the tire is mounted on a vehicle, and an inboard shoulder main groove 3a arranged in inwardmost fashion when the tire is mounted on the vehicle;

the plurality of land portions 4 through 6 include an outboard shoulder land portion 5 partitioned by the at least one contact patch end 2d and the outboard shoulder main groove 3b, and a inboard shoulder land portion 4 partitioned by the at least one contact patch end 2c and the inboard shoulder main groove 3a;

the outboard shoulder land portion 5 and the inboard shoulder land portion 4 respectively comprise a plurality of land grooves 7, 8 of groove width not less than 1.6 mm;

the plurality of land grooves 7, 8 comprise a plurality of outwardly open grooves 7 that extend as far as the at least one contact patch end 2c, 2d;

a total area of those 7 among the land grooves 7, 8 which are at the outboard shoulder land portion 5 is less than a total area of those 7, 8 among the land grooves 7, 8 which are at the inboard shoulder land portion 4; and

an average intersection angle θ2 which those 7 among the outwardly open grooves 7 which are at the outboard shoulder land portion 5 intersect a tire width direction D1 is less than an average intersection angle θ1 at which those 7 among the outwardly open grooves 7 which are at the inboard shoulder land portion 4 intersect the tire width direction D1.

In accordance with such constitution, because the total area of land grooves 7, 8 at inboard shoulder land portion 4 is made large, it is possible to suppress reduction in anti-hydroplaning performance. In addition, because the total area of land grooves 7 at outboard shoulder land portion 5 is made small, it is possible to suppress reduction in antinoise performance.

Furthermore, at inboard shoulder land portion 4, because the average intersection angle θ1 at which outwardly open grooves 7 intersect the tire width direction D1 is made large, there is a tendency for the length of said outwardly open grooves 7 to become large. As a result, because the area of outwardly open grooves 7 at inboard shoulder land portion 4 is made large, it is possible to suppress reduction in anti-hydroplaning performance.

What is more, at outboard shoulder land portion 5, because the average intersection angle θ2 at which outwardly open groove(s) 7 intersect the tire width direction D1 is made small, there is a tendency for the length of said outwardly open grooves 7 to become small. As a result, because the area of outwardly open grooves 7 at outboard shoulder land portion 5 is made small, it is possible to suppress reduction in antinoise performance.

Further, in the pneumatic tire 1 of the embodiment, an average groove width W2 of those 7 among the outwardly open grooves 7 which are at the outboard shoulder land portion 5 is less than an average groove width W1 of those 7 among the outwardly open grooves 7 which are at the inboard shoulder land portion 4.

In accordance with such constitution, because groove width(s) W1 of outwardly open groove(s) 7 at inboard shoulder land portion 4 is made large, it is possible to suppress reduction in anti-hydroplaning performance. What is more, because groove width(s) W2 of outwardly open groove(s) 7 at outboard shoulder land portion 5 is made small, it is possible to suppress reduction in antinoise performance.

Further, in the pneumatic tire 1 of the embodiment, a fractional percentage of inner ends 7b in the tire width direction D1 of those 7 among the outwardly open grooves which are at the outboard shoulder land portion 5 and which are contiguous with at least one of the shoulder main grooves 3b is less than a fractional percentage of inner ends 7b in the tire width direction D1 of those 7 among the outwardly open grooves 7 which are at the inboard shoulder land portion 4 and which are contiguous with at least one of the shoulder main grooves 3a.

In accordance with such constitution, because the fractional percentage of inner ends 7b in the tire width direction D1 of outwardly open grooves 7 that are contiguous with shoulder main groove(s) 3a at inboard shoulder land portion 4 is made large, it is possible to suppress reduction in anti-hydroplaning performance. What is more, because the fractional percentage of inner ends 7b in the tire width direction D1 of outwardly open grooves 7 that are contiguous with shoulder main groove(s) 3b at outboard shoulder land portion 5 is made small, it is possible to suppress reduction in antinoise performance.

The pneumatic tire is not limited to the configuration of the embodiment described above, and the effects are not limited to those described above. It goes without saying that the pneumatic tire 1 can be variously modified without departing from the scope of the subject matter of the present invention. For example, the constituents, methods, and the like of various modified examples described below may be arbitrarily selected and employed as the constituents, methods, and the like of the embodiments described above, as a matter of course.

(1) The constitution of pneumatic tire 1 associated with the foregoing embodiment is such that average groove width W2 of outwardly open groove(s) 7 at outboard shoulder land portion 5 is smaller than average groove width W1 of outwardly open groove(s) 7 at inboard shoulder land portion 4. However, while such constitution is preferred, pneumatic tire 1 is not limited to such constitution. For example, it is also possible to adopt a constitution in which average groove width W2 of outwardly open groove(s) 7 at outboard shoulder land portion 5 is the same as, or is larger than, average groove width W1 of outwardly open groove(s) 7 at inboard shoulder land portion 4.

(2) Furthermore, the constitution of pneumatic tire 1 associated with the foregoing embodiment is such that the fractional percentage of inner ends 7b of outwardly open grooves 7 that are contiguous with shoulder main groove(s) 3b at outboard shoulder land portion 5 is less than the fractional percentage of inner ends 7b outwardly open grooves 7 that are contiguous with shoulder main groove(s) 3a at inboard shoulder land portion 4. However, while such constitution is preferred pneumatic tire 1 is not limited to such constitution. For example, it is also possible to adopt a constitution in which the fractional percentage of inner ends 7b of outwardly open grooves 7 that are contiguous with shoulder main groove(s) 3b at outboard shoulder land portion 5 is the same as, or is greater than, the fractional percentage of inner ends 7b of outwardly open grooves 7 that are contiguous with shoulder main groove(s) 3a at inboard shoulder land portion 4.

(3) Furthermore, the constitution of pneumatic tire 1 associated with the foregoing embodiment is such that middle land portion(s) 6 comprise sipe(s) 9 but do not comprise land groove(s) 8. However, however, pneumatic tire 1 is not limited to such constitution. For example, it is also possible to adopt a constitution in which middle land portion(s) 6 comprise land groove(s) 8.

In accordance with such constitution, the constitution may be such that the total area of land grooves 8 at outboard middle land portion(s) 6 which are toward the exterior from tire equatorial plane S1 when the tire is mounted on the vehicle is, for example, less than the total area of land grooves 8 at inboard middle land portion(s) 6 which are toward the interior from tire equatorial plane S1 when the tire is mounted on the vehicle. Furthermore, for example, it is also possible to adopt a constitution in which average groove width of land grooves 8 at outboard middle land portion(s) 6 is less than average groove width of land grooves 8 at inboard middle land portion(s) 6. In accordance with such constitution, it will be possible to effectively suppress reduction in anti-hydroplaning performance, and it will also be possible to effectively suppress reduction in antinoise performance.

(4) Furthermore, at pneumatic tire 1, it is, for example, preferred that the void fraction (not including sipe(s) 9) of land groove(s) 7 at outboard shoulder land portion 5 be less than the void fraction (not including sipe(s) 9) of land groove(s) 7, 8 at inboard shoulder land portion 4. Note, however, that it is also possible, for example, to adopt a constitution in which the void fraction of land groove(s) 7 at outboard shoulder land portion 5 is the same as, or is greater than, the void fraction of land groove(s) 7, 8 at inboard shoulder land portion 4.

### EXAMPLES

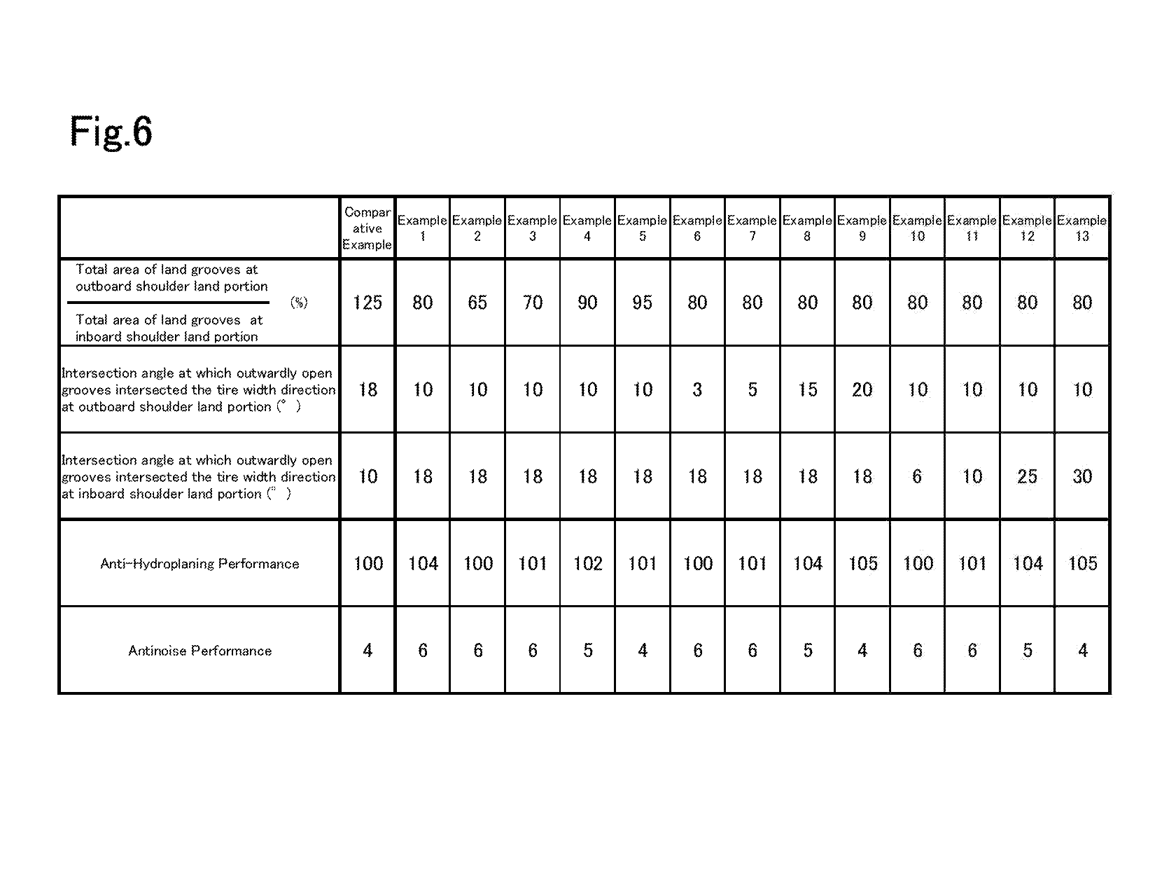

To illustrate the constitution and effect of tire 1 in specific terms, examples of tire 1 as well as comparative examples thereof are described below with reference to FIG. 6.

<Anti-Hydroplaning Performance>

The respective tires were mounted on a vehicle, driving was carried out on a road surface at which water depth was 8 mm, and the speed at which hydroplaning occurred was measured. Results of evaluation are shown as indexed relatives to a value of 100 for the Comparative Example, the larger the index the less likely the tendency for hydroplaning to occur and the better the anti-hydroplaning performance.

<Antinoise Performance>

The respective tires were mounted on a vehicle, and driving was carried out while driving straight ahead, turning, and changing lanes on a dry road surface. In addition, sensory tests carried out by the driver were employed for the purpose of evaluating antinoise performance on a scale comprising seven levels. Results of evaluation are shown as indexed relative to a value of 4 for the Comparative Example, the larger the index the better the antinoise performance.

### Example 1

Example 1 was a tire which had the following constitution.

(1) The ratio of the total area of land grooves 7, 8 at outboard shoulder land portion 5 to the total area of land grooves 7 at inboard shoulder land portion 4 was 80%.

(2) The average intersection angle θ2 at which outwardly open grooves 7 intersected the tire width direction D1 at outboard shoulder land portion 5 was 10°.

(3) The average intersection angle θ1 at which outwardly open grooves 7 intersected the tire width direction D1 at inboard shoulder land portion 4 was 18°.

### Examples 2 Through 13

At Examples 2 through 5, the tire associated with Example 1 was changed so as to be a tire for which “(1) the ratio of the total area of land grooves 7, 8 at outboard shoulder land portion 5 to the total area of land grooves 7 at inboard shoulder land portion 4” was respectively 65%, 70%, 90%, and 95%.

At Examples 6 through 9, the tire associated with Example 1 was changed so as to be a tire for which “(2) the average intersection angle θ2 at which outwardly open grooves 7 intersected the tire width direction D1 at outboard shoulder land portion 5” was respectively 3°, 5°, 15°, and 20°.

At Examples 10 through 13, the tire associated with Example 1 was changed so as to be a tire for which “(3) the average intersection angle θ1 at which outwardly open grooves 7 intersected the tire width direction D1 at inboard shoulder land portion 4” was respectively 6°, 10°, 25°, and 30°.

### Comparative Example

At the Comparative Example, the tire associated with Example 1 was changed so as to be a tire having the following constitution.

(1) The ratio of the total area of land grooves 7, 8 at outboard shoulder land portion 5 to the total area of land grooves 7 at inboard shoulder land portion 4 was 125% (=1/80%).

(2) The average intersection angle θ2 at which outwardly open grooves 7 intersected the tire width direction D1 at outboard shoulder land portion 5 was 18°.

(3) The average intersection angle θ1 at which outwardly open grooves 7 intersected the tire width direction D1 at inboard shoulder land portion 4 was 10°.

<Results of Evaluation>

As shown in FIG. 6, anti-hydroplaning performance was 100 or higher, and antinoise performance was 4 or higher, at Examples 1 through 13. Accordingly, it was possible to suppress reduction in hydroplaning performance and vet it was also possible to suppress reduction in antinoise performance.

What is more, at least one of either that anti-hydroplaning performance was 101 or higher, or that antinoise performance was 5 or higher, was satisfied. Accordingly, it was possible to improve at least one of either an hydroplaning performance or antinoise performance.

Furthermore, a preferred example of a tire is described below.

Anti-hydroplaning performance was 100 at Example 2, and antinoise performance was 4 at Example 5. In contradistinction thereto, anti-hydroplaning performance was 101 or higher, and antinoise performance was 5 or higher, at Examples 1, 3, and 4.

This being the case, it was possible to improve both anti-hydroplaning performance and antinoise performance at Examples 1, 3, and 4 relative to the situation at Examples 2 and 5. Accordingly, it is preferred that the ratio of the total area of land grooves 7 at outboard shoulder land portion 5 to the total area of land grooves 7, 8 at inboard shoulder land portion 4 be 70% to 90%. It should be noted, of course, that tire 1 is not limited to such range.

Anti-hydroplaning performance was 100 at Example 6, and antinoise performance was 4 at Example 9. In contradistinction thereto, anti-hydroplaning performance was 101 or higher, and antinoise performance was 5 or higher, at Examples 1, 7, and 8.

This being the case, it was possible to improve both anti-hydroplaning performance and antinoise performance at Examples 1, 7, and 8 relative to the situation at Examples 6 and 9. Accordingly, it is preferred that the average intersection angle θ2 at which outwardly open grooves 7 intersect the tire width direction D1 at outboard shoulder land portion 5 be 5° to 15°. It should be noted, of course, that tire 1 is not limited to such range.

Anti-hydroplaning performance was 100 at Example 10, and antinoise performance was 4 at Example 13. In contradistinction thereto, anti-hydroplaning performance was 101 or higher, and antinoise performance was 5 or higher, at Examples 1, 11, and 12.

This being the case, it was possible to improve both anti-hydroplaning performance and antinoise performance at Examples 1, 11, and 12 relative to the situation at Examples 10 and 13. Accordingly, it is preferred that the average intersection angle θ1 at which outwardly open grooves 7 intersect the tire width direction D1 at inboard shoulder land portion 4 be 10° to 25°. It should be noted, of course, that tire 1 is not limited to such range.

1. A pneumatic tire comprising:
a plurality of main grooves extending in a tire circumferential direction;
a plurality of land portions that are partitioned by at least one contact patch end and the plurality of main grooves; and
at least one indicator region that indicates a vehicle mounting direction;
wherein the plurality of main grooves include an outboard shoulder main groove arranged in outwardmost fashion when the tire is mounted on a vehicle, and an inboard shoulder main groove arranged in inwardmost fashion when the tire is mounted on the vehicle;
the plurality of land portions include an outboard shoulder land portion partitioned by the at least one contact patch end and the outboard shoulder main groove, and a inboard shoulder land portion partitioned by the at least one contact patch end and the inboard shoulder main groove;
the outboard shoulder land portion and the inboard shoulder land portion respectively comprise a plurality of land grooves of groove width not less than 1.6 mm;
the plurality of land grooves comprise a plurality of outwardly open grooves that extend as far as the at least one contact patch end;
a total area of those among the land grooves which are at the outboard shoulder land portion is less than a total area of those among the land grooves which are at the inboard shoulder land portion; and
an average intersection angle at which those among the outwardly open grooves which are at the outboard shoulder land portion intersect a tire width direction is less than an average intersection angle at which those among the outwardly open grooves which are at the inboard shoulder land portion intersect the tire width direction.

2. The pneumatic tire according to claim 1 wherein an average groove width of those among the outwardly open grooves which are at the outboard shoulder land portion is less than an average groove width of those among the outwardly open grooves which are at the inboard shoulder land portion.

3. The pneumatic tire according to claim 1 wherein a fractional percentage of inner ends in the tire width direction of those among the outwardly open grooves which are at the outboard shoulder land portion and which are contiguous with at least one of the shoulder main grooves is less than a fractional percentage of inner ends in the tire width direction of those among the outwardly open grooves which are at the inboard shoulder land portion and which are contiguous with at least one of the shoulder main grooves.

4. The pneumatic tire according to claim 3 wherein all of the inner ends in the tire width direction of those among the outwardly open grooves which are at the outboard shoulder land portion are contiguous with the outboard shoulder main grooves.

5. The pneumatic tire according to claim 3 wherein all of the inner ends in the tire width direction of those among the outwardly open grooves which are at the inboard shoulder land portion are separated from the inboard shoulder main grooves.

6. The pneumatic tire according to claim 1 wherein a ratio of the total area of the land grooves at the outboard shoulder land portion is 70% to 90% of the total area of the land grooves at the inboard shoulder land portion.

7. The pneumatic tire according to claim 1 wherein
the average intersection angle at which those among the outwardly open grooves which are at the outboard shoulder land portion intersect the tire width direction is 5° to 15°; and
the average intersection angle at which those among the outwardly open grooves which are at the inboard shoulder land portion intersect the tire width direction is 10° to 25°.

8. The pneumatic tire according to claim 1 wherein a void ratio of the land grooves of groove width not less than 1.6 mm at the outboard shoulder land portion is less than a void ratio of the land grooves of groove width not less than 1.6 mm at the inboard shoulder land portion.

9. The pneumatic tire according to claim 1 wherein
the plurality of land portions comprise a plurality of middle land portions arranged between the outboard shoulder land portion and the inboard shoulder land portion;
the plurality of middle land portions include at least one outboard middle land portion arranged to the exterior side of a tire equatorial plane when the tire is mounted on the vehicle, and at least one inboard middle land portion arranged to the interior side of the tire equatorial plane when the tire is mounted on the vehicle;
the at least one outboard middle land portion and the at least one inboard middle land portion respectively comprise a plurality of land grooves of groove width not less than 1.6 mm; and
a total area of those among the land grooves which are at the at least one outboard middle land portion is less than a total area of those among the land grooves which are at the at least one inboard middle land portion.
